(19) United States
(12) Patent Application Publication
(10) Pub. No.: US 2006/0179090 A1
(43) Pub. Date: Aug. 10, 2006

(54) System and method for converting binary to decimal

(75) Inventors: Steven R. Carlough, Poughkeepsie, NY (US); Bruce M. Fleischer, Bedford Hills, NY (US); Wen H. Li, Poughkeepsie, NY (US); Eric M. Schwarz, Gardiner, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: International Business Machines Corporation, Armonk, NY (US)

(21) Appl. No.: 11/054,232

(22) Filed: Feb. 9, 2005

(51) Int. Cl. G06F 7/00

(52) U.S. Cl. 708/204

(57) ABSTRACT

A method for converting from binary to decimal. The method includes receiving a binary number, the binary number including one or more sets of bits. An accumulated sum is set to zero. The accumulated sum is in a binary coded decimal (BCD) format. The following loop is repeated for each set of bits in the binary number in order from the set of bits containing the most significant bit of the binary number to the set of bits containing the least significant bit of the binary number: the accumulated sum is converted into a 5,1 code format resulting in an interim sum. The loop also includes repeating for each next bit in the set in order from the most significant bit to the least significant bit in the set: doubling the interim sum; and replacing the least significant bit of the interim sum with the next bit. The last step in the loop includes converting the interim sum into the BCD format and storing the results of the converting in the accumulated sum. Once all of the sets of bits in the binary number have been processed through the loop, the accumulated sum is output as the final result.

### TRADEMARKS

IBM® is a registered trademark of International Business Machines Corporation, Armonk, N.Y., U.S.A. S/390, Z900 and z990 and other names used herein may be registered trademarks, trademarks or product names of International Business Machines Corporation or other companies.

### BACKGROUND OF THE INVENTION

This invention relates generally to data conversion, and more particularly, to converting a number from binary to decimal using a five bit code.

Decimal calculations are becoming more prevalent in today's computers. For example, all financial calculations are inherently decimal calculations. However, most computers operate more efficiently on binary data because the digital circuits are optimized for two-value logic. This causes a need to convert decimal formats to binary formats and vice versa. Currently, look-up tables and decimal adders to accumulate the results are utilized to perform conversions from binary formats to decimal formats. In designs where the frequency is very high, a decimal adder requires multiple cycles. Also there are space concerns associated with using look-up tables. In addition, the use of a look-up table can have negative impact on the speed of the conversion. It would be desirable to be able to perform the conversion from binary to decimal as efficiently as possible in order to provide a high performance computer system.

### BRIEF SUMMARY OF THE INVENTION

Exemplary embodiments of the present invention include a method for converting from binary to decimal. The method includes receiving a binary number, the binary number including one or more sets of bits. An accumulated sum is set to zero. The accumulated sum is in a binary coded decimal (BCD) format. The following loop is repeated for each set of bits in the binary number in order from the set of bits containing the most significant bit of the binary number to the set of bits containing the least significant bit of the binary number: the accumulated sum is converted into a 5,1 code format resulting in an interim sum. The loop also includes repeating for each next bit in the set in order from the most significant bit to the least significant bit in the set: doubling the interim sum; and replacing the least significant bit of the interim sum with the next bit. The last step in the loop includes converting the interim sum into the BCD format and storing the results of the converting in the accumulated sum. Once all of the sets of bits in the binary number have been processed through the loop, the accumulated sum is output as the final result.

Additional exemplary embodiments include a method for converting from binary to decimal. The method includes receiving a binary number, the binary number including one or more sets of bits. An accumulated sum is set to zero, where the accumulated sum is in a binary coded decimal (BCD) format. The accumulated sum is converted into a 5,1 code format resulting in an interim sum. The following loop is repeated for each set of bits in the binary number in order from the set of bits containing the most significant bit of the binary number to the set of bits containing the least significant bit of the binary number: repeating for each next bit in the set in order from the most significant bit to the least significant bit in the set: doubling the interim sum; and replacing the least significant bit of the interim sum with the next bit. At the end of the loop the interim sum is converted into the BCD format and storing the result in the accumulated sum the accumulated sum is output as the final result.

Additional exemplary embodiments include a system for converting from binary to decimal. The system includes an input latch for storing a binary number that includes one or more sets of bits. The system also includes an accumulated sum latch for storing a BCD formatted accumulated sum and an interim sum latch for storing a 5,1 code formatted interim sum. The system further includes a mechanism for receiving the binary number into the input latch and setting the accumulated sum to zero. The following loop is repeated for each set of bits in the binary number in order from the set of bits containing the most significant bit of the binary number to the set of bits containing the least significant bit of the binary number: the accumulated sum is converted into a 5,1 code format resulting in an interim sum. The loop also includes repeating for each next bit in the set in order from the most significant bit to the least significant bit in the set: doubling the interim sum; and replacing the least significant bit of the interim sum with the next bit. The last step in the loop includes converting the interim sum into the BCD format and storing the results of the converting in the accumulated sum. Once all of the sets of bits in the binary number have been processed through the loop, the accumulated sum is output as the final result.

Further exemplary embodiments include a system for converting from binary to decimal. The system includes an input latch for storing a binary number that includes one or more sets of bits. The system also includes an accumulated sum latch for storing a BCD formatted accumulated sum and an interim sum latch for storing a 5,1 code formatted interim sum. The system further includes a mechanism for receiving the binary number into the input latch and setting the accumulated sum to zero. The accumulated sum is converted into a 5,1 code format resulting in the interim sum. The following loop is repeated for each set of bits in the binary number in order from the set of bits containing the most significant bit of the binary number to the set of bits containing the least significant bit of the binary number: repeating for each next bit in the set in order from the most significant bit to the least significant bit in the set: doubling the interim sum; and replacing the least significant bit of the interim sum with the next bit. At the end of the loop the interim sum is converted into the BCD format and storing the result in the accumulated sum the accumulated sum is output as the final result.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a binary to decimal converter that may be utilized by exemplary embodiments of the present invention;

FIG. 2 is a block diagram of a binary to decimal converter that may be utilized by exemplary embodiments of the present invention;

FIG. 3 is a table that depicts BCD digits and corresponding 5,1 code digits as utilized by exemplary embodiments of the present invention;

FIG. 4 depicts circuitry for an exemplary BCD to 5,1 code recoder that may be utilized by exemplary embodiments of the present invention;

FIG. 5 depicts circuitry for an exemplary 5,1 code to BCD recoder that may be utilized by exemplary embodiments of the present invention; and

FIG. 6 depicts circuitry for an exemplary 5,1 code doubler that may be utilized by exemplary embodiments of the present invention.

The detailed description explains the preferred embodiments of the invention, together with advantages and features, by way of example with reference to the drawings.

### DETAILED DESCRIPTION OF THE PREFERRED EMBODIMENTS

Exemplary embodiments of the present invention include an algorithm for converting binary data to binary coded decimal (BCD) data. The algorithm is very efficient and may be implemented in machines with very fast cycle times. The conversion algorithm converts one binary bit to decimal and accumulates it. The speed of exemplary embodiments of the circuitry associated with the algorithm allows multiple circuits to be concatenated together to reduce multiple bits per cycle. In exemplary embodiments of the present invention, four stages per cycle are assembled to reduce four binary bits per cycle. This could easily be modified to do more or less bits per cycle because the building block is very small.

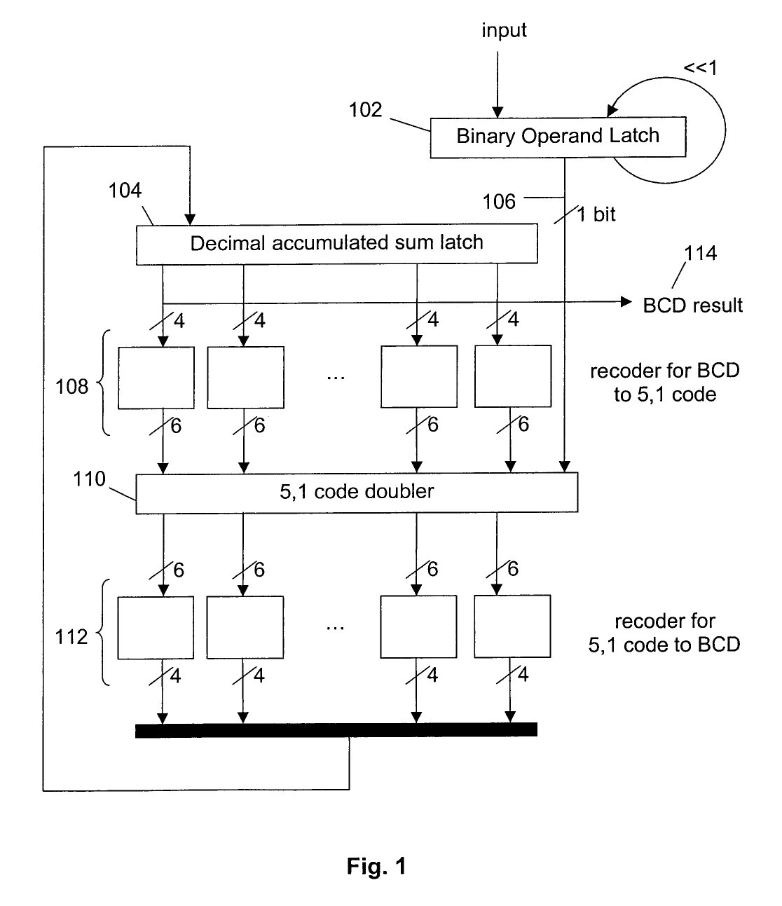

FIG. 1 is a block diagram of a binary to decimal converter that may be utilized by exemplary embodiments of the present invention. It includes a binary operand latch 102 for storing a binary operand that will be converted to a BCD format. The binary operand latch 102 shifts left once for each cycle through the processing depicted in FIG. 1. In this manner it feeds the MSB of the binary operand into the 5,1 code doubler 110 during the first cycle, the second MSB during the second cycle, the third MSB during the third cycle and so on until all bits in the binary operand latch 102 have been input to the 5,1 code doubler 110.

Also included in the binary to decimal converter depicted in FIG. 1 is a decimal accumulated sum latch 104 for storing a running sum associated with the resultant BCD number. At the start of the conversion process, the decimal accumulated sum latch 104 is reset to zero. Output from the decimal accumulated sum latch 104 includes digits in a BCD format. At the end of the conversion, the decimal accumulated sum latch 104 contains the final BCD result 114.

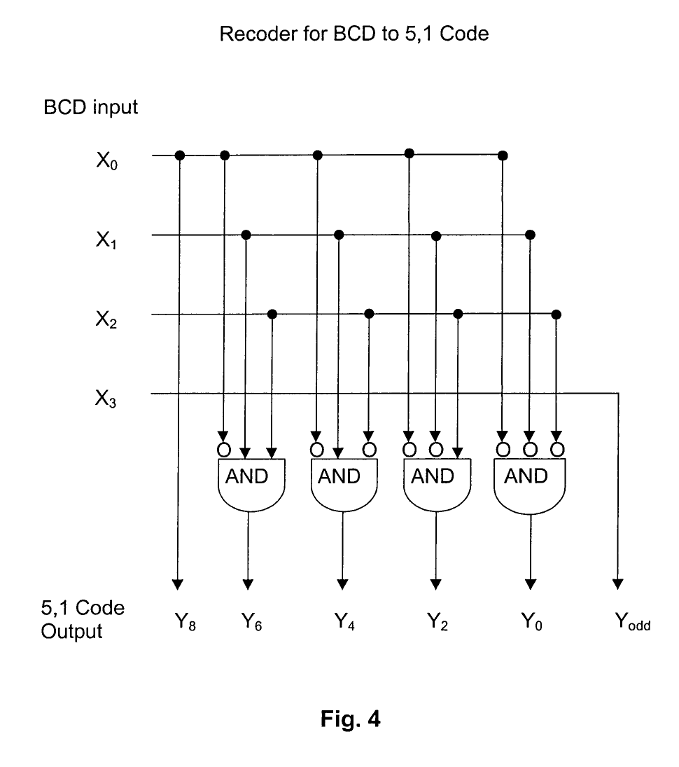

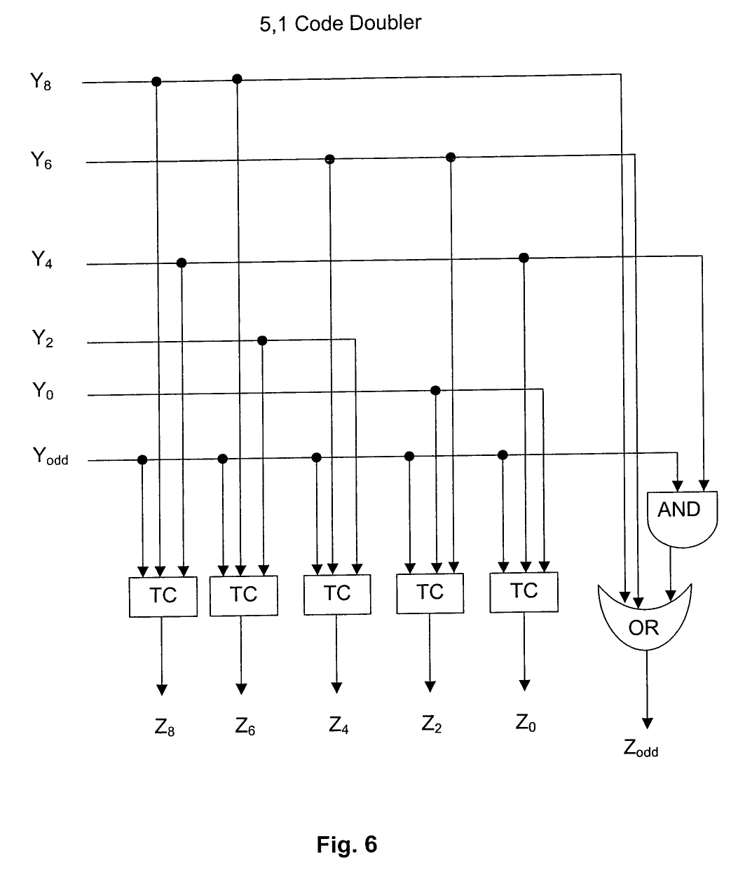

The BCD formatted data from the decimal accumulated sum latch 104 is input to a BCD to 5,1 code recoder 108 for converting the BCD formatted data into 5,1 code formatted data. Exemplary circuitry that may be utilized to implement the BCD to 5,1 code recoder 108 is depicted in FIG. 4 and described below. The output from the BCD to 5,1 code recoder 108 and the next most significant binary bit 106 of the binary operand is input to a 5,1 code doubler 110. The 5,1 code doubler 110 performs the conversion from binary to 5,1 code format. Exemplary circuitry that may be utilized to implement the 5,1 code doubler 110 is depicted in FIG. 6 and described below. Output from the 5,1 code doubler 110 is in a 5,1 code format and is input to a 5,1 code to BCD recoder 112. The 5,1 code to BCD recoder 112 converts the 5,1 code data into BCD data. The BCD data that is output is then input to the decimal accumulated sum latch 104 for use during the next cycle through the processing depicted in FIG. 1.

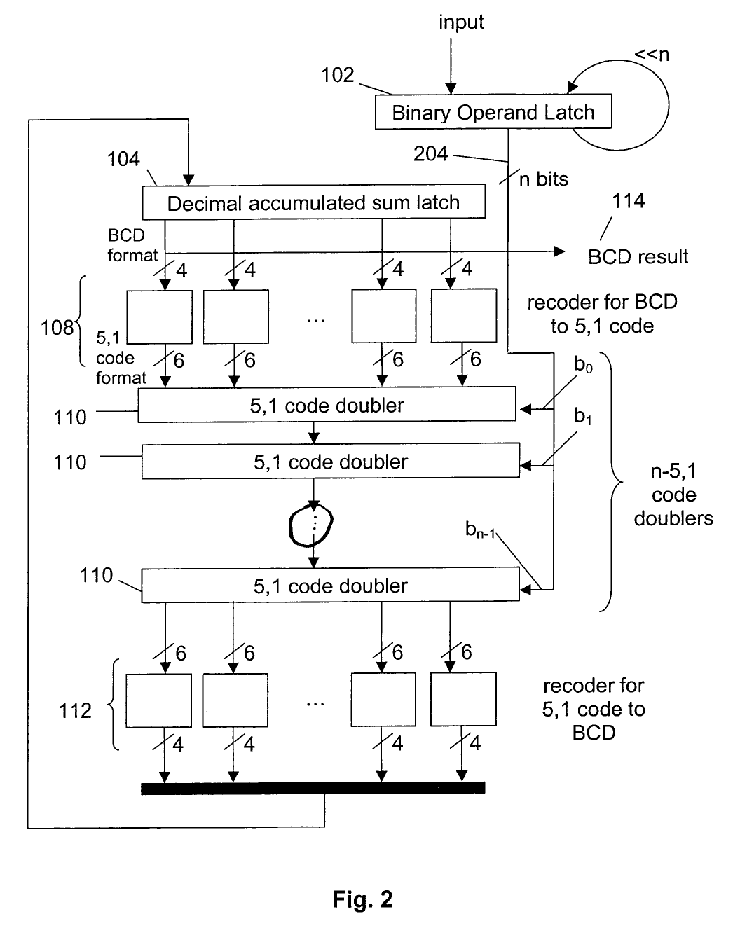

FIG. 2 is a block diagram of a binary to decimal converter that may be utilized by exemplary embodiments of the present invention. It is similar to the binary to decimal converter depicted in FIG. 1 except that more than one bit of data is being converted in each cycle. The binary operand latch 102 is shifted left “n bits” and the “n bits” are fed to “n” 5,1 code doublers 110, as depicted in FIG. 2. In this manner n bits are being converted during each cycle. This results in a higher performance binary to decimal converter than the one depicted in FIG. 1 because more bits are being converted per cycle.

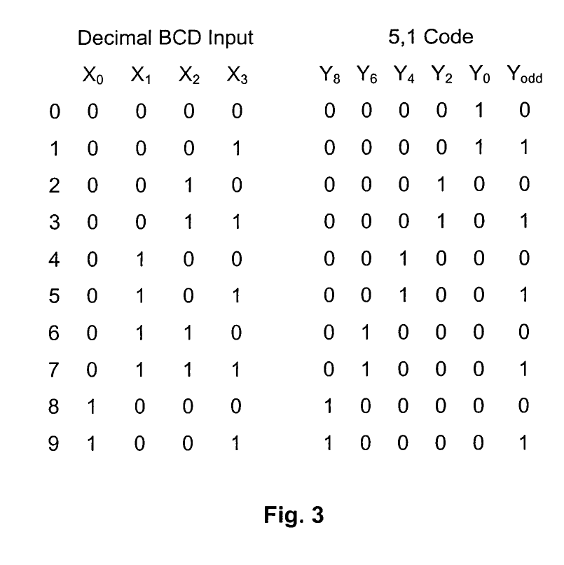

FIG. 3 is a table that depicts BCD digits and corresponding 5,1 code digits as utilized by exemplary embodiments of the present invention. The conversion is based on the following logic. First, when doubling a BCD digit, the carryout propagates to the LSB of the next most significant digit (MSD), and the LSB of the digits is always zero.

As shown below:

0000→0000

0001→0010

0010→0100

0011→0110

0100→1000

0101→1,0000

0110→1,0010

0111→1,0100

1000→1,0110

1001→1,1000

In the above list, the number preceding the comma is the carry out (e.g., for entry “1, 0000”, “1” is the carry out). The LSB of the result is always zero and the carry out may be held for the next less significant doubled digit. When the BCD is recoded to five bits with weights of 8, 6, 4, 2, 0, respectively, and one additional bit indicates whether the value is odd or even, the result is the values depicted in FIG. 3.

The following is an example of a conversion from binary to BCD utilizing exemplary embodiments of the present invention as described herein. In this example, 4 bits are being converted per cycle (i.e., four 5,1 code doublers 110 are utilized) and, for simplicity of the example, the resulting BCD number has a maximum of two digits. The number to be converted is binary “00100100” which will become “00110110” in BCD via the processes and circuitry described herein.

b₀ b₁ b₂ b₃ b₄ b₅ b₆ b₇
0 0 1 0 0 1 0 0
FIRST LOOP:
BCD to 5,1 Code Recoder:

| | |
|---|---|
| 1^{st} digit = 0000 BCD | 2^{nd} digit = 0000 BCD |
| 1^{st} digit = 000010 5,1 Code | 2^{nd} digit = 000010 5,1 Code |

1^{st} 5,1 Code Doubler:

| | |
|---|---|
| 1^{st} digit = 000010 5,1 Code | 2^{nd} digit = 000010 5,1 Code |

Double 2^{nd} digit and replace LSB with b₀

2^{nd} digit = 000010 5,1 Code
Carry out from 2^{nd} digit is 0

Double 1^{st} digit and replace LSB with carry out from 2^{nd} digit

1^{st} digit = 000010 5,1 Code

2^{nd} 5,1 Code Doubler:

| | |
|---|---|
| 1^{st} digit = 000010 5,1 Code | 2^{nd} digit = 000010 5,1 Code |

Double 2^{nd} digit and replace LSB with b₁

2^{nd} digit = 000010 5,1 Code
Carry out from 2^{nd} digit is 0

Double 1^{st} digit and replace LSB with carry out from 2^{nd} digit

1^{st} digit = 000010 5,1 Code

3^{rd} 5,1 Code Doubler:

| | |
|---|---|
| 1^{st} digit = 000010 5,1 Code | 2^{nd} digit = 000010 5,1 Code |

Double 2^{nd} digit and replace LSB with b₂

2^{nd} digit = 000011 5,1 Code
Carry out from 2^{nd} digit is 0

Double 1^{st} digit and replace LSB with carry out from 2^{nd} digit

1^{st} digit = 000010 5,1 Code

4^{th} 5,1 Code Doubler:

| | |
|---|---|
| 1^{st} digit = 000010 5,1 Code | 2^{nd} digit = 000011 5,1 Code |

Double 2^{nd} digit and replace LSB with b₃

2^{nd} digit = 000100 5,1 Code
Carry out from 2^{nd} digit is 0

Double 1^{st} digit and replace LSB with carry out from 2^{nd} digit

1^{st} digit = 000010 5,1 Code

5,1 Code to BCD Recoder:

| | |
|---|---|
| 1^{st} digit = 000010 5,1 Code | 2^{nd} digit = 000100 5, 1 Code |
| 1^{st} digit = 0000 BCD | 2^{nd} digit = 0010 BCD |

SECOND LOOP
BCD to 5,1 Code recoder:

| | |
|---|---|
| 1^{st} digit = 0000 BCD | 2^{nd} digit = 0010 BCD |
| 1^{st} digit = 000010 5,1 Code | 2^{nd} digit = 000100 5,1 Code |

1^{st} 5,1 Code Doubler:

| | |
|---|---|
| 1^{st} digit = 000010 5,1 Code | 2^{nd} digit = 000100 5,1 Code |

Double 2^{nd} digit and replace LSB with b₄

2^{nd} digit = 001000 5,1 Code
Carry out from 2^{nd} digit is 0

Double 1^{st} digit and replace LSB with carry out from 2^{nd} digit

1^{st} digit = 000010 5,1 Code

2^{nd} 5,1 Code Doubler:

| | |
|---|---|
| 1^{st} digit = 000010 5,1 Code | 2^{nd} digit = 001000 5,1 Code |

Double 2^{nd} digit and replace LSB with b₅

2^{nd} digit = 100001 5,1 Code
Carry out from 2^{nd} digit is 0

Double 1^{st} digit and replace LSB with carry out from 2^{nd} digit

1^{st} digit = 000010 5,1 Code

3^{rd} 5,1 Code Doubler:

| | |
|---|---|
| 1^{st} digit = 000010 5,1 Code | 2^{nd} digit = 100001 5,1 Code |

Double 2^{nd} digit and replace LSB with b₆

2^{nd} digit = 100000 5,1 Code
Carry out from 2^{nd} digit is 1

Double 1^{st} digit and replace LSB with carry out from 2^{nd} digit

1^{st} digit = 000011 5,1 Code

4^{th} 5,1 Code Doubler:

| | |
|---|---|
| 1^{st} digit = 000011 5,1 Code | 2^{nd} digit = 100000 5,1 Code |

Double 2^{nd} digit and replace LSB with b₇

2^{nd} digit = 010000 5,1 Code
Carry out from 2^{nd} digit is 1

Double 1^{st} digit and replace LSB with carry out from 2^{nd} digit

1^{st} digit = 000101 5,1 Code

5,1 Code to BCD Recoder:

| | |
|---|---|
| 1^{st} digit = 000101 5,1 Code | 2^{nd} digit = 010000 5, 1 Code |
| 1^{st} digit = 0011 BCD | 2^{nd} digit = 0110 BCD |

BCD Result = 00110110

FIG. 4 depicts circuitry for an exemplary BCD to 5,1 code recoder that may be utilized by exemplary embodiments of the present invention. The four bits making up one BCD digit (i.e., X₀, X₁, X₂, and X₃) are input and the output result is the six bits making up the corresponding 5,1 code digit (i.e., Y₈, Y₆, Y₄, Y₂, Y₀, and Y_{odd}).

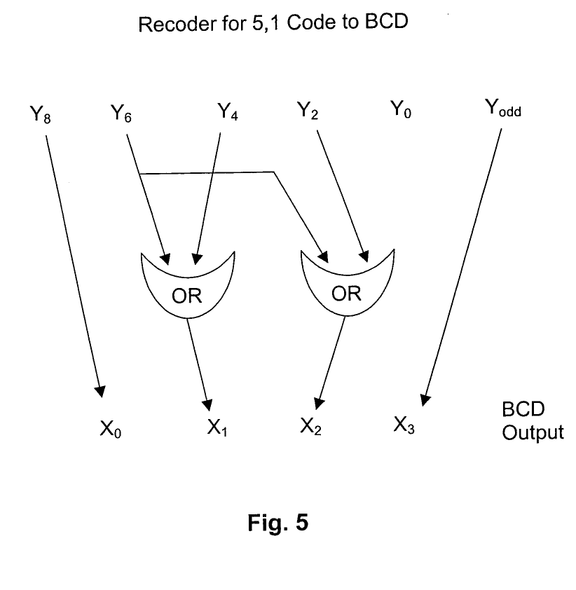

FIG. 5 depicts circuitry for an exemplary 5,1 code to BCD recoder that may be utilized by exemplary embodiments of the present invention. The five bits making up a 5,1 code digit (i.e., Y₈, Y₆, Y₄, Y₂, Y₀, and Y_{odd}) are input and the output result is the four bits making up the corresponding BCD digit (i.e., X₀, X₁, X₂, and X₃).

FIG. 6 depicts circuitry for an exemplary 5,1 code doubler that may be utilized by exemplary embodiments of the present invention. A digit expressed in 5,1 code is input (i.e., Y) and the output is the digit doubled (i.e., Z) and expressed in 5,1 code. The circuitry depicted in FIG. 6 may be expressed by the formulas that follow.
Z₈=Y_{odd}*Y₈+\overline{Y}_{odd}Y₄
Z₆=Y_{odd}*Y₂+\overline{Y}_{odd}*Y₈
Z₄=Y_{odd}*Y₆+\overline{Y}_{odd}*Y₂
Z₂=Y_{odd}*Y₀+\overline{Y}_{odd}*Y₆
Z₀=Y_{odd}*Y₄+\overline{Y}_{odd}*Y₀
Z_{odd}=Y₈+Y₆+Y_{odd}*Y₄ for all but the least significant group
Z_{odd}=bᵢ for the least significant bit
Note that Z_{odd} is actually the carry out of this digit and it is transmitted to the next more significant digit, whereas Z8, Z6, Z4, Z2, and Z0 remain with the positional weighting of the current digit.

Exemplary embodiments of the present invention provide an efficient binary to decimal converter. Converting to 5,1 code allows the doubling to be performed without the performance impacts associated with propagated carry chains. The 5,1 code also allows most of the equations (Z8, Z6, Z4, Z2, and Z0) to be expressed in terms of 2 to 1 multiplexer where the select signals are the true and complement of Y_{odd}. This type of multiplexer is extremely fast if implemented in circuits as a pass gate multiplexer, and has a speed advantage over prior art BCD doublers. In exemplary embodiments of the present invention four bits are converted during each clock cycle providing for a relatively quick conversion between a binary number and a BCD number.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for converting from binary to decimal, the method comprising:
receiving a binary number, the binary number including one or more sets of bits;
setting an accumulated sum to zero, wherein the accumulated sum is in a binary coded decimal (BCD) format;
repeating for each set of bits in the binary number in order from the set of bits containing the most significant bit of the binary number to the set of bits containing the least significant bit of the binary number:
converting the accumulated sum into a 5,1 code format resulting in an interim sum; and
repeating for each next bit in the set in order from the most significant bit to the least significant bit in the set:
doubling the interim sum; and
replacing the least significant bit of the interim sum with the next bit; and
converting the interim sum into the BCD format and storing the result in the accumulated sum; and
outputting the accumulated sum as the final result.

2. The method of claim 1 wherein each set includes four bits.

3. The method of claim 1 wherein each set includes one bit.

4. The method of claim 1 wherein the final result includes up to sixteen digits.

5. The method claim 1 wherein the final result includes up to thirty four digits.

6. A method for converting from binary to decimal, the method comprising:
receiving a binary number, the binary number including one or more sets of bits;
setting an accumulated sum to zero, wherein the accumulated sum is in a binary coded decimal (BCD) format;
converting the accumulated sum into a 5,1 code format resulting in an interim sum;
repeating for each set of bits in the binary number in order from the set of bits containing the most significant bit of the binary number to the set of bits containing the least significant bit of the binary number:
repeating for each next bit in the set in order from the most significant bit to the least significant bit in the set:
doubling the interim sum; and
replacing the least significant bit of the interim sum with the next bit;
converting the interim sum into the BCD format and storing the result in the accumulated sum; and
outputting the accumulated sum as the final result.

7. A system for converting from binary to decimal, the system comprising:
an input latch for storing a binary number that includes one or more sets of bits;
an accumulated sum latch for storing a BCD formatted accumulated sum;
an interim sum latch for storing a 5,1 code formatted interim sum;
a mechanism for:
receiving the binary number into the input latch;
setting the accumulated sum to zero;
repeating for each set of bits in the binary number in order from the set of bits containing the most significant bits of the binary number to the set of bits containing the least significant bits of the binary number:
converting the accumulated sum into a 5,1 code format resulting in the interim sum; and
repeating for each next bit in the set in order from the most significant bit to the least significant bit in the set:
doubling the interim sum; and
replacing the least significant bit of the interim sum with the next bit; and
converting the interim sum into the BCD format and storing the result in the accumulated sum; and
outputting the accumulated sum as the final result.

8. The system of claim 7 wherein each set includes four bits.

9. The system of claim 7 wherein each set includes one bit.

10. The system of claim 7 wherein the doubling and the replacing are performed by a 5,1 code doubler.

11. The system of claim 7 wherein the final result includes up to sixteen digits.

12. The system of claim 7 wherein the final result includes up to thirty four digits.

13. A system for converting from binary to decimal, the system comprising:
an input latch for storing a binary number that includes one or more sets of bits;
an accumulated sum latch for storing a BCD formatted accumulated sum;
an interim sum latch for storing a 5,1 code formatted interim sum;
a mechanism for:
receiving the binary number into the input latch;
setting the accumulated sum to zero;
converting the accumulated sum into a 5,1 code format resulting in the interim sum;
repeating for each set of bits in the binary number in order from the set of bits containing the most significant bit of the binary number to the set of bits containing the least significant bit of the binary number:
repeating for each next bit in the set in order from the most significant bit to the least significant bit in the set:
doubling the interim sum; and
replacing the least significant bit of the interim sum with the next bit;
converting the interim sum into the BCD format and storing the result in the accumulated sum; and
outputting the accumulated sum as the final result.
